(19) United States
(12) Patent Application Publication
(10) Pub. No.: US 2014/0092995 A1
(43) Pub. Date: Apr. 3, 2014

(54) ELECTRONIC DEVICES FOR SIGNALING A RANDOM ACCESS POINT PICTURE MESSAGE

(71) Applicant: Sharp Laboratories of America, Inc., Camas, WA (US)

(72) Inventor: Sachin G. Deshpande, Camas, WA (US)

(73) Assignee: Sharp Laboratories of America, Inc., Camas, WA (US)

(21) Appl. No.: 14/040,566

(22) Filed: Sep. 27, 2013

Related U.S. Application Data
(60) Provisional application No. 61/707,819, filed on Sep. 28, 2012.

(51) Int. Cl. H04N 7/26

(52) U.S. Cl. CPC H04N 19/00903
USPC 375/240.26

(57) ABSTRACT

An electronic device for sending a message is described. The electronic device includes a processor and instructions stored in memory that is in electronic communication with the processor. The electronic device determines whether a picture is a random access point (RAP) picture. If the picture is a RAP picture, the electronic device generates a message including a RAP network access layer (NAL) unit type (NUT) and a RAP information parameter. If the picture is a RAP picture, the message does not include a NAL unit header (NUH) temporal identifier parameter. The electronic device sends the message.

### RELATED APPLICATION

This application is related to and claims priority from U.S. Provisional Patent Application No. 61/707,819 entitled “ELECTRONIC DEVICES FOR SIGNALING A RANDOM ACCESS POINT PICTURE MESSAGE,” filed on Sep. 28, 2012, which is incorporated herein by reference.

### TECHNICAL FIELD

The present disclosure relates generally to electronic devices. More specifically, the present disclosure relates to electronic devices for signaling a random access point (RAP) picture message.

### BACKGROUND

Electronic devices have become smaller and more powerful in order to meet consumer needs and to improve portability and convenience. Consumers have become dependent upon electronic devices and have come to expect increased functionality. Some examples of electronic devices include desktop computers, laptop computers, cellular phones, smart phones, media players, integrated circuits, etc.

Some electronic devices are used for processing and displaying digital media. For example, portable electronic devices now allow for digital media to be consumed at almost any location where a consumer may be. Furthermore, some electronic devices may provide download or streaming of digital media content for the use and enjoyment of a consumer.

The increasing popularity of digital media has presented several problems. For example, efficiently representing high-quality digital media for storage, transmittal and rapid playback presents several challenges. As can be observed from this discussion, systems and methods that represent digital media efficiently with improved performance may be beneficial.

### BRIEF DESCRIPTION OF THE DRAWINGS

FIG. 1 is a block diagram illustrating an example of one or more electronic devices in which systems and methods for signaling a random access point (RAP) picture message may be implemented;

FIG. 2 is a flow diagram illustrating one configuration of a method for sending a message;

FIG. 3 is a flow diagram illustrating a more specific configuration of a method for sending a message;

FIG. 4 is a block diagram illustrating one configuration of an encoder on an electronic device;

FIG. 5 is a flow diagram illustrating one configuration of a method for receiving a message;

FIG. 6 is a flow diagram illustrating a more specific configuration of a method for receiving a message;

FIG. 7 is a block diagram illustrating one configuration of a decoder on an electronic device;

FIG. 8 illustrates various components that may be utilized in a transmitting electronic device;

FIG. 9 is a block diagram illustrating various components that may be utilized in a receiving electronic device;

FIG. 10 is a block diagram illustrating one configuration of an electronic device in which systems and methods for sending a random access point (RAP) picture message may be implemented; and

FIG. 11 is a block diagram illustrating one configuration of an electronic device in which systems and methods for receiving a random access point (RAP) picture message may be implemented.

### DETAILED DESCRIPTION

An electronic device for sending a message is described. The electronic device includes a processor and instructions stored in memory that is in electronic communication with the processor. The electronic device determines whether a picture is a random access point (RAP) picture. If the picture is a RAP picture, the electronic device generates a message including a RAP network access layer (NAL) unit type (NUT) and a RAP information parameter. If the picture is a RAP picture, the message does not include a NAL unit header (NUH) temporal identifier parameter. The electronic device sends the message.

The RAP NUT may be the only NAL unit type to indicate a RAP NAL unit type. The RAP NUT may be RAP_NUT. The RAP NUT value may equal 7.

The RAP information parameter may specify a RAP NAL unit type as a broken link access (BLA) with leading pictures (LP), a BLA with decodable leading pictures (DLP), a BLA with no leading pictures (LP), an instantaneous decoding refresh (IDR) with DLP, an IDR with no leading pictures (LP), or a clean random access (CRA) NUT. The BLA with LP RAP NAL unit type may be BLA_W_LP, the BLA with DLP RAP NAL unit type may be BLA_W_DLP, the BLA with no LP RAP NAL unit type may be BLA_N_LP, the IDR with DLP RAP NAL unit type may be IDR_W_DLP, the IDR with no LP RAP NAL unit type may be IDR_N_LP, and the CRA NUT RAP NAL unit type may be CRA_NUT.

The RAP information parameter may be rap_nal_unit_type. The RAP information parameter may be 3 bits. The RAP information parameter may be signaled using the same bits in the message as a nuh_temporal_id_plus1 parameter. The value of temporal identifier may be automatically inferred to be 0 in this case.

The RAP information parameter may replace a nuh_temporal_id_plus1 parameter in a bitstream if the picture may be a RAP picture. The RAP picture NAL unit type may be a BLA with LP, a BLA with DLP, a BLA with no LP, an IDR with DLP, an IDR with no LP, or a CRA NUT.

The RAP information parameter may be a RAP identifier parameter. The RAP identifier parameter may be rap_id.

The RAP information parameter may be a NUH reserved parameter. The NUH reserved parameter may be nuh_reserved_one_{—}3bits. The NUH reserved parameter may be nuh_reserved_zero_{—}3bits. The RAP information parameter may be a RAP priority index parameter.

The RAP priority index parameter may be priority_idx. The RAP information parameter may be a RAP picture indicator flag. The RAP picture indicator flag may be no_output_of prior_pics_flag.

The electronic device may generate a message including a NUH temporal identifier parameter if the picture may not be a RAP picture. The NUH temporal identifier parameter may be nuh_temperal_id_plus1. The message may be a NAL unit header message.

An electronic device for receiving a message is described. The electronic device includes a processor and instructions stored in memory that is in electronic communication with the processor. The electronic device determines whether a RAP network access layer (NAL) unit type (NUT) and/or a RAP picture NAL unit type is present in the message. If a RAP network access layer (NAL) unit type (NUT) and/or a RAP picture NAL unit type is present in the message, the electronic device obtains a RAP information parameter from the message and the electronic device decodes a picture based on the RAP information parameter. The value of temporal identifier may be automatically inferred to be 0 in this case

The RAP NUT may be the only NAL unit type to indicate a RAP NAL unit type. The RAP NUT may be RAP_NUT. The RAP NUT value may equal 7.

The RAP information parameter may specify a RAP NAL unit type as one of a broken link access (BLA) with leading pictures (LP), a BLA with decodable leading pictures (DLP), a BLA with no LP, an instantaneous decoding refresh (IDR) with DLP, an IDR with no LP, or a clean random access (CRA) NUT. The BLA with LP RAP NAL unit type may be BLA_W_LP, the BLA with DLP RAP NAL unit type may be BLA_W_DLP, the BLA with no LP RAP NAL unit type may be BLA_N_LP, the IDR with DLP RAP NAL unit type may be IDR_W_DLP, the IDR with no LP RAP NAL unit type may be IDR_N_LP, and the CRA NUT RAP NAL unit type may be CRA_NUT.

The RAP information parameter may be rap_nal_unit_type. The RAP information parameter may be 3 bits. The RAP information parameter may be signaled using the same bits in the message as a nuh_temporal_id_plus1 parameter. The RAP information parameter may replace a nuh_temporal_id_plus1 parameter in a bitstream if the RAP NUT may be present.

The RAP picture NAL unit type may be a BLA with LP, a BLA with DLP, a BLA with no LP, an IDR with DLP, an IDR with no LP, or a CRA NUT. The RAP information parameter may be a RAP identifier parameter. The RAP information parameter may be a NUH reserved parameter.

The RAP information parameter may be a RAP priority index parameter. The RAP information parameter may be a RAP picture indicator flag.

If the RAP NAL unit type is not present in the message, the electronic device may obtain a NUH temporal identifier parameter from the message. The NUH temporal identifier parameter may be nuh_temperal_id_plus1. The message may be a NAL unit header message.

A method for sending a message is also described. It is determined whether a picture is a random access point (RAP) picture. If the picture is a RAP picture, then a message is generated including a RAP network access layer (NAL) unit type (NUT) and/or a RAP picture NAL unit type. The message also includes a RAP information parameter. The message does not include a NAL unit header (NUH) temporal identifier parameter. If the picture is a RAP picture, then the message is sent.

A method for receiving a message is also described. A message is received. It is determined whether a RAP network access layer (NAL) unit type (NUT) and/or a RAP picture NAL unit type is present in the message. If a RAP network access layer (NAL) unit type (NUT) and/or a RAP picture NAL unit type is present in the message, then a RAP information parameter is obtained from the message and a picture is decoded based on the RAP information parameter.

The systems and methods disclosed herein describe electronic devices for signaling a RAP picture message. A RAP picture contains only I slices, and may be a broken link access (BLA) picture, a clean random access (CRA) picture or an instantaneous decoding refresh (IDR) picture. The first picture in the bitstream must be a RAP picture. For example, the RAP picture message may be a network access layer (NAL) unit header message having information corresponding to a RAP picture.

As described herein, alternate approaches to known methods may be employed for sending and receiving a RAP picture message. In some approaches, a single NAL unit type may be employed to indicate a RAP picture. Additionally, the 3 bits that make up the NAL unit header (NUH) temporal identifier parameter in the NAL unit header may be reused to signal the RAP NAL unit type as one of 6 RAP picture types.

The NUH temporal identifier parameter may be nuh_temporal_id_plus1 and may specify the temporal id of a corresponding picture. However, in the case of a RAP picture, the NUH temporal identifier parameter specifies the temporal id to be equal to zero. By definition, a RAP picture has a temporal id equal to zero, thus the NUH temporal identifier parameter is redundant and unnecessary in the case of a RAP picture.

In another approach, instead of signaling the temporal id value of a RAP picture using the NUH temporal identifier parameter, a RAP identifier, such as rap_id, may be signaled. The RAP identifier may assist in distinguishing between back-to-back IDR pictures. This may be beneficial, for example, in distinguishing picture slices that are mixed during network transmission or that arrive out of order.

In one approach, instead of signaling the temporal id value of a RAP picture using the NUH temporal identifier parameter, a NUH reserved parameter may be signaled. The NUH reserved parameter may correspond to the RAP picture and may be nuh_reserved_one_{—}3bits or nuh_reserved_zero_{—}3bits, for example. In some configurations, the NUH reserved parameter may be used for scalability purposes.

In another approach, instead of signaling the temporal id value of a RAP picture using the NUH temporal identifier parameter, a priority index parameter, such as priority_idx, may be signalled. The priority index parameter may be a value that indicates the priority of a RAP picture.

In some known configurations, such as in Benjamin Bros et al., “High efficiency video coding (HEVC) text specification draft 8,” JCTVC-J1003_d7, Stockholm, July 2012 (hereinafter “HEVC Draft 8”), syntax and semantics for signaling various types of random access point (RAP) pictures are described. The systems and methods disclosed herein may describe modifications to the syntax and semantics presented in HEVC Draft 8.

Modifications to the syntax and semantics presented in HEVC Draft 8 may provide for more efficient approaches for sending RAP picture messages. RAP picture information may be sent in a NAL unit header rather than sending redundant or unnecessary data in the NAL unit header. For instance, RAP picture information may be sent in place of redundant and/or unnecessary temporal id information in the NAL unit header corresponding to a RAP picture. For example, in HEVC Draft 8, when a RAP picture is signalled, the syntax element nuh_temporal_id_plus1 is required to be signalled to indicate TemporalId equal to 0. This is because, by definition, the temporal id of a RAP picture equals zero. The syntax element nuh_temporal_id_plus1 is found in the NAL unit header and is 3 bits. Therefore, three bits may be repurposed to send information about the RAP picture rather than sending redundant and/or unnecessary data about the temporal layer of the RAP picture.

Table 1, below, illustrates one example of modified syntax and semantics in accordance with the systems and methods disclosed herein. Modifications in accordance with the systems and methods disclosed herein are denoted in bold.

TABLE 1

nal_unit_header( ) {

forbidden_zero_bit
nal_unit_type
nuh_reserved_zero_6bits

if(nal_{—}unit_{—}type==RAP_{—}NUT)

rap_{—}nal_{—}unit_{—}type

else

nuh_{—}temporal_{—}id_{—}plus1

}

Examples regarding NAL unit header semantics in accordance with the systems and methods disclosed herein are given as follows. In particular, additional detail regarding the semantics of the modified syntax elements are given as follows. forbidden_zero_bit may be equal to 0.

nal_unit_type may specify the type of raw byte sequence payload (RBSP) data structure included in the NAL unit as specified in Table 2, below. NAL units that use nal_unit_type equal to UNSPEC0 or in the range of UNSPEC48 to UNSPEC63, inclusive, for which semantics are not specified, may not affect the decoding process specified in HEVC Draft 8. It should be noted that NAL unit types UNSPEC0 and UNSPEC48 to UNSPEC63 may be used as determined by an application (e.g., encoders and/or decoders). Since different applications might use NAL unit types UNSPEC0 and UNSPEC48 to UNSPEC63 for different purposes, particular care must be exercised in the design of encoders that generate NAL units with nal_unit_type equal to UNSPEC0 or UNSPEC48 to UNSPEC63, and in the design of decoders that interpret the content of NAL units with nal_unit_type equal to UNSPEC0 or UNSPEC48 to UNSPEC63.

Decoders may ignore (remove from the bitstream and discard) the contents of all NAL units that use reserved values of nal_unit_type. For example, the decoder may remove from the bitstream and all NAL units having reserved nal_unit_type values.

Table 2, below, illustrates NAL unit type codes (e.g., NAL unit types, names and content) according to the systems and methods described herein. Terms used in Table 2 include temporal sub-layer access (TSA), step-wise temporal sub-layer access (STSA), random access point (RAP), instantaneous decoding refresh (IDR), broken link access (BLA), clean random access (CRA), decodable leading pictures (DLP), tagged for discard (TFD) and supplemental enhancement information (SEI). Modifications are denoted in bold.

TABLE 2

| | Name of | Content of NAL unit and |
|---|---|---|
| nal_unit_type | nal_unit_type | RBSP syntax structure |
| 0 | UNSPEC0 | Unspecified |
| 1, 2 | TRAIL_R, | Coded slice of a non-TSA, |
| | TRAIL_N | non-STSA trailing picture |
| | | slice_layer_rbsp( ) |
| 3, 4 | TSA_R, | Coded slice of a TSA picture |
| | TSA_N | slice_layer_rbsp( ) |
| 5, 6 | STSA_R, | Coded slice of an STSA picture |
| | STSA_N | slice_layer_rbsp( ) |
| 7 | RAP_{—}NUT | Coded slice of a RAP (IDR/BLA/ |
| | | CRA) picture |
| 8-12 | RSV_{—}VCL8 . . . | Reserved |
| | RSV_{—}VCL12 | |
| 13 | DLP_NUT | Coded slice of a DLP picture |
| | | slice_layer_rbsp( ) |
| 14 | TFD_NUT | Coded slice of a TFD picture |
| | | slice_layer_rbsp( ) |
| 15 . . . 20 | RSV_VCL15 . . . | Reserved |
| | RSV_VCL20 | |
| 21 . . . 24 | RSV_NVCL21 . . . | Reserved |
| | RSV_NVCL24 | |
| 25 | VPS_NUT | Video parameter set |
| | | video_parameter_set_rbsp( ) |
| 26 | SPS_NUT | Sequence parameter set |
| | | seq_parameter_set_rbsp( ) |
| 27 | PPS_NUT | Picture parameter set |
| | | pic_parameter_set_rbsp( ) |
| 28 | AUD_NUT | Access unit delimiter |
| | | access_unit_delimiter_rbsp( ) |
| 29 | EOS_NUT | End of sequence |
| | | end_of_seq_rbsp( ) |
| 30 | EOB_NUT | End of bitsteam |
| | | end_of_bitstream_rbsp( ) |
| 31 | FD_NUT | Filler data |
| | | filler_data_rbsp( ) |
| 32 | SEI_NUT | SEI |
| | | sei_rbsp( ) |
| 33 . . . 47 | RSV_NVCL33 . . . | Reserved |
| | RSV_NVCL47 | |
| 48 . . . 63 | UNSPEC48 . . . | Unspecified |
| | UNSPEC63 | |

In Table 2, RAP_NUT may be the name of the nal_unit_type that indicates a corresponding picture is a RAP picture. The temporal identifier of a RAP_NAL may equal zero.

RAP_NUT may have a nal_unit_type equal to 7. Thus, under this approach, former nal_unit_type that used to range from 7 to 12, inclusive, to indicate a coded slice of a RAP picture may be consolidated into a single nal_unit_type, RAP_NUT. In some configurations, the nal_unit_type for RAP_NUT may be assigned a value different than the value 7. Also, the nal_unit_type values for other NUTs may be changed. The additionally freed NAL unit types 8-12 may be kept reserved or unspecified. In some configurations, NAL unit types 8-12 may be used to signal other types of NAL unit types and/or NAL unit sub-types.

RAP_NUT may indicate a code slice of a RAP picture, such as an IDR, a BLA or a CRA picture. A RAP NAL unit type (NUT) (e.g., NAL unit sub-type for a RAP picture) may be further specified, as illustrated in Table 3, below.

TABLE 3

| | Name of | Content of RAP NAL unit |
|---|---|---|
| rap_nal_unit_type | rap_nal_unit_type | and RBSP syntax structure |
| 1, 2, 3 | BLA_W_LP | Coded slice of a BLA picture |
| | BLA_W_DLP | slice_layer_rbsp( ) |
| | BLA_N_LP | |
| 4, 5 | IDR_W_LP, | Coded slice of an IDR picture |
| | IDR_N_LP | slice_layer_rbsp( ) |
| 6 | CRA_NUT | Coded slice of a CRA picture |
| | | slice_layer_rbsp( ) |
| 0, 7 | | Reserved |

In Table 3, rap_nal_unit_type may specify the RAP NAL unit type when the nal_unit_type indicates coded slice of a RAP picture (e.g., RAP_NUT). rap_nal_unit_types 1-3 may include coded slice of a broken link access (BLA) picture. For example, rap_nal_unit_type 1 may be a BLA with leading pictures (LP) RAP NAL unit type, such as BLA_W_LP. rap_nal_unit_type 2 may be a BLA with decodable leading pictures (DLP) NAL unit type, such as BLA_W_DLP. rap_nal_unit_type 3 may be a BLA with no leading pictures (LP) NAL unit type, such as BLA_N_LP. For instance, RAP NAL unit types BLA_W_LP, BLA_W_DLP, BLA_N_LP, IDR_W_DLP, IDR_N_LP and CRA_NUT may be referred to as NAL unit sub-types for a RAP picture.

rap_nal_unit_types 4 and 5 may include an instantaneous decoding refresh (IDR) picture. For example, rap_nal_unit_type 4 may be an IDR with DLP RAP NAL unit type, such as IDR_W_DLP. rap_nal_unit_type 5 may be an IDR with no LP RAP NAL unit type, such as IDR_N_LP.

rap_nal_unit_type 6 may include a clean random access (CRA) picture. For example, rap_nal_unit_type 6 may be a CRA NAL unit type (NUT) RAP NAL unit type, such as CRA_NUT. Other values of rap_nal_unit_types from 0 to 7, inclusive, may be assigned to BLA_W_LP, BLA_W_DLP, BLA_N_LP, IDR_W_DLP, IDR_N_LP and CRA_NUT than those shown in Table 3.

The rap_nal_unit_types from 1-6, inclusive, may have a video coding layer (VCL) NAL unit type. rap_nal_unit_types 0 and 7 may have a non-VCL NAL unit type class. rap_nal_unit_types 0 and 7 may be reserved for future use.

Returning to Table 1, nuh_reserved_zero_{—}6bits may be equal to 0. Other values of nuh_reserved_zero_{—}6bits may be specified in future standards. Decoders may ignore (i.e., remove from the bitstream and discard) all NAL units with values of nuh_reserved_zero_{—}6bits not equal to 0.

nuh_temporal_id_plus1 minus 1 may specify a temporal identifier for the NAL unit. The variable TemporalId may be specified as TemporalId=nuh_temporal_id_plus1−1.

When nal_unit_type is in the range of 3 to 6, inclusive (e.g., coded slice of a temporal sub-layer access (TSA) or step-wise temporal sub-layer access (STSA) picture), TemporalId may not be equal to 0. When nal_unit_type equals 7 (e.g., RAP_NUT) and rap_nal_unit_type is in the range of 1 to 6 (e.g., a coded slice of a RAP picture such as BLA_W_LP, BLA_W_DLP, BLA_N_LP, IDR_W_DLP, IDR_N_LP and CRA_NUT), inclusive, TemporalId value may be automatically inferred and set to 0.

The value of TemporalId may be the same for all VCL NAL units of an access unit. The value of TemporalId of an access unit may be the value of the TemporalId of the VCL NAL units of the access unit.

The value of TemporalId for non-VCL NAL units may be constrained as follows. If nal_unit_type is equal to VPS_NUT, SPS_NUT, EOS_NUT or EOB_NUT, then TemporalId may be equal to 0. If nal_unit_type is equal to AUD_NUT or FD_NUT, then TemporalId may be equal to the TemporalId of the access unit containing the non-VCL NAL unit. Otherwise, when nal_unit_type is equal to SEI_NUT, then TemporalId may be equal to or greater than the TemporalId of the access unit containing the NAL unit.

It should be noted that when the NAL unit is a non-VCL NAL unit, the value of TemporalId may be equal to the minimum value of the TemporalId values of all access units that the non-VCL NAL unit applies to. When nal_unit_type is equal to VPS_NUT or SPS_NUT, TemporalId may be equal to 0, as a sequence parameter set may apply at least to one RAP access unit. When nal_unit_type is equal to AUD_NUT or FD_NUT, TemporalId may be equal to the TemporalId of the access unit containing the non-VCL NAL unit, as access unit delimiter or filler data may only apply to the containing access unit. When nal_unit_type is equal to PPS_NUT, TemporalId may be less than, equal to, or greater than the TemporalId of the containing access unit, as a picture parameter set may be repeated in access units not referring to the picture parameter set (e.g., for error resilience purposes), and all picture parameter sets may be included in the beginning of a bitstream, where the first coded picture has TemporalId equal to 0. When nal_unit_type is equal to SEI_NUT, TemporalId may be equal to or greater than the TemporalId of the containing access unit, as a supplemental enhancement information (SEI) NAL unit may include a picture buffering SEI message or a picture timing SEI message that applies to a bitstream subset that includes access units for which the TemporalId values are greater than the TemporalId of the access unit containing the SEI NAL unit.

In another configuration, a RAP identifier may be signalled in the NAL unit header. Table 4, below, illustrates syntax that may be employed to signal a RAP identifier. Modifications in accordance with the systems and methods disclosed herein are denoted in bold.

TABLE 4

nal_unit_header( ) {

forbidden_zero_bit
nal_unit_type
nuh_reserved_zero_6bits

if(nal_{—}unit_{—}type== BLA_{—}W_{—}LP || nal_{—}unit_{—}type==BLA_{—}W_{—}DLP ||
nal_{—}unit_{—}type==BLA_{—}N_{—}LP || nal_{—}unit_{—}type== IDR_{—}W_{—}DLP ||
nal_{—}unit_{—}type== IDR_{—}N_{—}LP || nal_{—}unit_{—}type== CRA_{—}NUT)

rap_{—}id

else

nuh_{—}temporal_{—}id_{—}plus1

}

In Table 4, all the existing NAL unit types for BLA_W_LP, BLA_W_DLP, BLA_N_LP, IDR_W_DLP, IDR_N_LP and CRA_NUT (e.g., NAL unit types 7 to 12) are kept as in the current HEVC Draft specification (i.e., HEVC Draft 8). In some cases, the rap_id may be signalled for only some of the RAP NAL unit types (e.g. only for nal_unit_type==IDR_W_DLP and nal_unit_type==IDR_N_LP).

rap_id may identify a RAP picture. The values of rap_id in all the slices of a RAP picture may remain unchanged. In other words, for a particular RAP picture, the same value of rap_id should be signalled for all slices of that picture. For example, for a first RAP picture, the value of rap_id may be 1 for all slices of that RAP picture. For the next RAP picture, the value of rap_id may be 2 for all slices of that RAP picture, etc.

The value of rap_id may range from 1 to 7, inclusive. In general, a value of 0 is prevented from being used to avoid start code emulation prevention. However, in some configurations, the value of rap_id may range from 0 to 7, inclusive. It should also be appreciated that in some configurations, other ranges of numbers may be employed.

rap_id may be an identifier, similar to a picture id or a frame number. For example, rap_id may be incremented by 1 each time a new RAP picture is sent in the bitstream. In other words, rap_id may wrap around after the bit precision field is used. For instance, once rap_id has incremented from 1 to 7, rap_id may rap around and again restart at 1.

When two consecutive access units in decoding order are both RAP access units, the value of rap_id in the slices of the first such RAP access unit may differ from the rap_id in the second such RAP access unit. For example, in the case of two consecutive (e.g., back-to-back) IDR access units, the rap_id of the first access unit is not equal to the rap_id of the second access unit. In this manner, back-to-back IDR pictures may be distinguishable. This may be beneficial, for example, in distinguishing picture slices that are mixed, that arrive out of order or get lost and never arrive.

In one configuration, a NUH reserved parameter may be signalled in the NAL unit header. Table 5, below, illustrates syntax that may be employed to signal a NUH reserved parameter. Modifications in accordance with the systems and methods disclosed herein are denoted in bold.

TABLE 5

nal_unit_header( ) {

forbidden_zero_bit
nal_unit_type
nuh_reserved_zero_6bits

if(nal_{—}unit_{—}type== BLA_{—}W_{—}LP || nal_{—}unit_{—}type==BLA_{—}W_{—}DLP ||
nal_{—}unit_{—}type==BLA_{—}N_{—}LP || nal_{—}unit_{—}type== IDR_{—}W_{—}DLP ||
nal_{—}unit_{—}type== IDR_{—}N_{—}LP || nal_{—}unit_{—}type== CRA_{—}NUT)

nuh_{—}reserved_{—}one_{—}3bits

else

nuh_{—}temporal_{—}id_{—}plus1

}

In Table 5, all the existing NAL unit types for BLA_W_LP, BLA_W_DLP, BLA_N_LP, IDR_W_DLP, IDR_N_LP and CRA_NUT (e.g., NAL unit types 7 to 12) are kept as in the current HEVC Draft specification (e.g., HEVC Draft 8). In some cases, the NUH reserved parameter may be signalled for only some of the RAP NAL unit types (e.g. only for nal_unit_type==IDR_W_DLP and nal_unit_type==IDR_N_LP).

nuh_reserved_one_{—}3bits may be equal to 8. In other words, each bit of the 3 bits may be equal to 1. Other values of nuh_reserved_one_{—}3bits may be specified in future specifications. Decoders may ignore all NAL units with values of nuh_reserved_one_{—}3bits not equal to 8. For example, a decoder may remove from the bitstream and discard a NAL unit with a value of nuh_reserved_one_{—}3bits not equal to 8.

In another configuration, the field nuh_reserved_one_{—}3bits could instead be nuh_reserved_zero_{—}3bits with semantics defined as follows. nuh_reserved_zero_{—}3bits may be equal to 0. Other values of nuh_reserved_zero_{—}3bits may be specified in future specifications. Decoders may ignore, remove from the bitstream and/or discard all NAL units with values of nuh_reserved_zero_{—}3bits not equal to 0.

In some configurations, a RAP priority index may be signalled in the NAL unit header. Table 6, below, illustrates syntax that may be employed to signal a RAP priority index. Modifications in accordance with the systems and methods disclosed herein are denoted in bold.

TABLE 6

nal_unit_header( ) {

forbidden_zero_bit
nal_unit_type
nuh_reserved_zero_6bits

if(nal_{—}unit_{—}type== BLA_{—}W_{—}LP || nal_{—}unit_{—}type==BLA_{—}W_{—}DLP ||
nal_{—}unit_{—}type==BLA_{—}N_{—}LP || nal_{—}unit_{—}type== IDR_{—}W_{—}DLP ||
nal_{—}unit_{—}type== IDR_{—}N_{—}LP || nal_{—}unit_{—}type== CRA_{—}NUT)

priority_{—}idx

else

nuh_{—}temporal_{—}id_{—}plus1

}

In Table 6, all the existing NAL unit types for BLA_W_LP, BLA_W_DLP, BLA_N_LP, IDR_W_DLP, IDR_N_LP and CRA_NUT (e.g., NAL unit types 7 to 12) are kept as in the current HEVC Draft specification (e.g., HEVC Draft 8). In some cases, the RAP priority index may be signalled for only some of the RAP NAL unit types (e.g. only for nal_unit_type==IDR_W_DLP and nal_unit_type==IDR_N_LP).

priority_idx may identify the priority of a RAP picture. The value of priority_idx may range from 1 to 7, inclusive. The RAP priority index may indicate the priority of the NAL unit. An application (e.g., encoder or decoder) may define how to allocate the RAP priority.

In one example, RAP priority may be used for determining which RAP picture is more important in terms of distortion reduction. For instance, the RAP priority index may be assigned based on the expected reduction in distortion that is achieved when using the rate-distortion optimized streaming of packetized media.

In another configuration, one or more syntax elements from a slice header could be signalled in place of the NUH temporal identifier parameter in the slice header. For example, a RAP picture indicator flag may be employed. The RAP picture indicator flag may use 1 bit and may signal a RAP picture. For example, the RAP picture indicator flag may be a flag indicating no output of prior pictures (e.g., no_output_of prior_pics_flag). Additionally or alternatively, other syntax elements corresponding to RAP pictures may be employed in place of the NUH temporal identifier parameter, which required 3 bits.

As illustrated by the foregoing, the systems and methods disclosed herein provide syntax and semantics that modify a NAL header unit for signaling a RAP information parameter. For example, a RAP NAL unit type (NUT) may indicate the presence of a RAP information parameter, such as a RAP NAL unit type parameter, a RAP identifier parameter, a NUH reserved parameter, a RAP priority index parameter and/or a RAP picture indicator flag. In some configurations, the systems and methods disclosed herein may be applied to HEVC specifications.

In some configurations, an additional flag variable RapPicFlag may be derived as follows. RapPicFlag=(nal_unit_type==IDR_W_DLP∥nal_unit_type==IDR_N_LP∥nal_unit_type==BLA_W_LP∥nal_unit_type==BLA_W_DLP∥nal_unit_type==BLA_N_LP∥nal_unit_type==CRA_NUT). In this manner, the if statement in Table 4, Table 5 and Table 6 may check the value of RapPicFlag. In other words, if the condition “if(RapPicFlag)” is true, then the RAP information message may be signalled. It should be noted that the if statement in Table 4, Table 5 and Table 6 may be modified to state “if(RapPicFlag).”

For convenience, several definitions are given as follows, which may be applied to the systems and methods disclosed herein. A random access point may be any point in a stream of data (e.g., bitstream) where decoding of the bitstream does not require access to any point in a bitstream preceding the random access point to decode a current picture and all pictures subsequent to said current picture in output order.

A picture parameter set (PPS) is a syntax structure containing syntax elements that apply to 0 or more entire coded pictures as determined by the pic_parameter_set_id syntax element found in each slice header. pic_parameter_set_id may identify the picture parameter set that is referred to in the slice header. The value of pic_parameter_set_id may be in the range of 0 to 255, inclusive.

A coded picture buffer (CPB) may be a first-in first-out buffer containing access units in decoding order specified in a hypothetical reference decoder (HRD). An access unit may be a set of NAL units that are consecutive in decoding order and include exactly one coded picture. In addition to the coded slice NAL units of the coded picture, the access unit may also include other NAL units not containing slices of the coded picture. The decoding of an access unit always results in a decoded picture. A NAL unit may be a syntax structure containing an indication of the type of data to follow and bytes containing that data in the form of a raw byte sequence payload interspersed as necessary with emulation prevention bytes.

Various configurations are now described with reference to the figures, where like reference numbers may indicate functionally similar elements. The systems and methods as generally described and illustrated in the figures herein could be arranged and designed in a wide variety of different configurations. Thus, the following more detailed description of several configurations, as represented in the figures, is not intended to limit scope, as claimed, but is merely representative of the systems and methods.

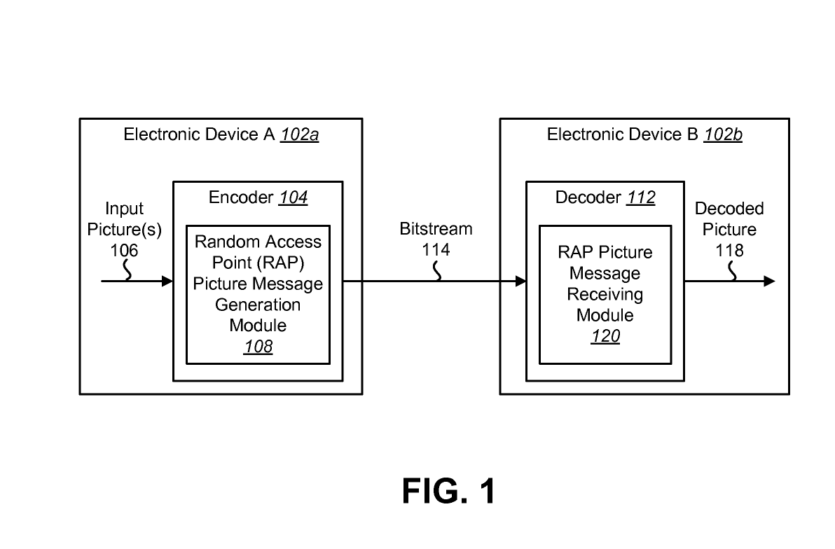

FIG. 1 is a block diagram illustrating an example of one or more electronic devices 102 in which systems and methods for signaling a random access point (RAP) picture message may be implemented. In this example, electronic device A 102a and electronic device B 102b are illustrated. However, it should be noted that one or more of the features and functionality described in relation to electronic device A 102a and electronic device B 102b may be combined into a single electronic device in some configurations.

Electronic device A 102a includes an encoder 104. The encoder 104 includes a RAP picture message generation module 108. Each of the elements included within electronic device A 102a (e.g., the encoder 104 and the RAP picture message generation module 108) may be implemented in hardware, software or a combination of both.

Electronic device A 102a may obtain one or more input pictures 106. In some configurations, the input picture(s) 106 may be captured on electronic device A 102a using an image sensor, may be retrieved from memory and/or may be received from another electronic device.

The encoder 104 may encode the input picture(s) 106 to produce encoded data. For example, the encoder 104 may encode a series of input pictures 106 (e.g., video). For instance, the encoder 104 may encode one or more RAP pictures. In one configuration, the encoder 104 may be an HEVC encoder. The encoded data may be digital data (e.g., part of a bitstream 114). The encoder 104 may generate overhead signaling based on the input signal.

The RAP picture message generation module 108 may generate one or more messages. For example, the RAP picture message generation module 108 may generate one or more RAP picture messages, NAL unit header messages or other messages. A RAP picture message may be a network access layer (NAL) unit header message having information corresponding to a RAP picture. If the NAL unit header message corresponds to a RAP picture, the NAL unit header may include information regarding the RAP picture. The NAL unit header message may be part of a NAL unit message. In some cases, a NAL unit header message may always be part of a NAL unit.

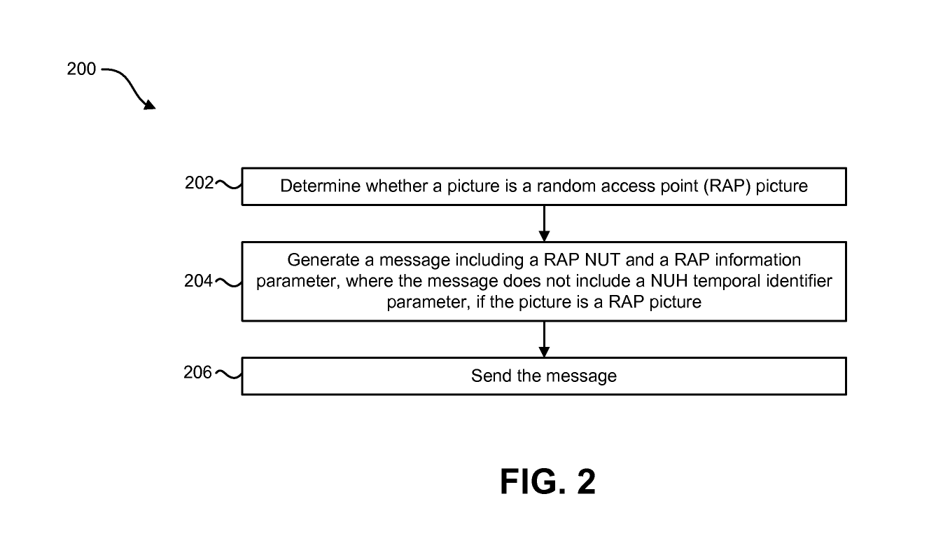

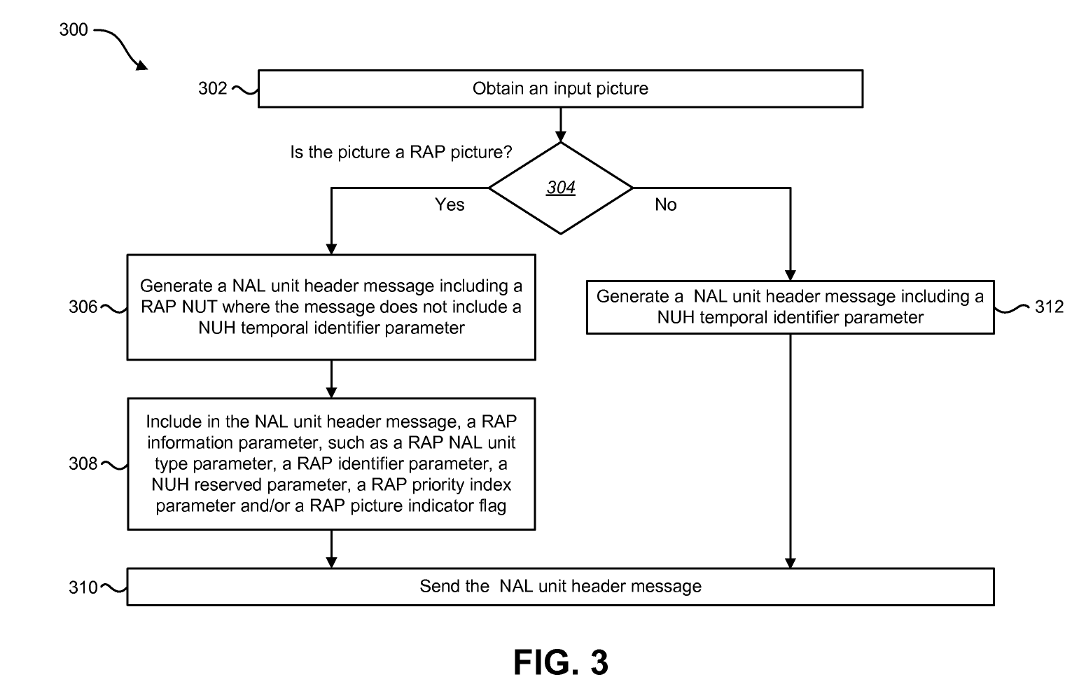

The electronic device 102 (e.g., the encoder 104) may determine whether a picture (e.g., an encoded picture) is a RAP picture. If the picture is a RAP picture then the RAP picture message generation module 108 may generate a RAP picture message (e.g., NAL unit header messages or other message) that includes one or more of a RAP NAL unit type parameter (e.g., rap_nal_unit_type), a RAP identifier parameter (e.g., rap_id), a NUH reserved parameter (e.g., nuh_reserved_one_{—}3bits or nuh_reserved_zero_{—}3bits), a RAP priority index parameter (e.g., priority_idx) and/or a RAP picture indicator flag (e.g., no_output_of prior_pics_flag). For example, the RAP picture message generation module 108 may perform one or more of the procedures described in connection with FIG. 2 and FIG. 3 below.

In some configurations, electronic device A 102a may send the message to electronic device B 102b as part of the bitstream 114. In some configurations electronic device A 102a may send the message to electronic device B 102b by a separate transmission (not shown). For example, the separate transmission may not be part of the bitstream 114. For instance, a NAL unit header or other message may be sent using some out-of-band mechanism. It should be noted that, in some configurations, the other message may include one or more of the features of a RAP picture message (e.g., NAL unit header message having RAP picture information) described above. Furthermore, the other message, in one or more aspects, may be utilized similarly to the NAL unit message described above.

The encoder 104 (and RAP picture message generation module 108, for example) may produce a bitstream 114. The bitstream 114 may include encoded picture data based on the input picture(s) 106. In some configurations, the bitstream 114 may also include overhead data, such as a NAL unit header message or other message, slice header(s), PPS(s), etc. As additional input pictures 106 are encoded, the bitstream 114 may include one or more encoded pictures. For instance, the bitstream 114 may include one or more encoded pictures with corresponding overhead data (e.g., a NAL unit header message or other message).

The bitstream 114 may be provided to a decoder 112. In one example, the bitstream 114 may be transmitted to electronic device B 102b using a wired or wireless link. In some cases, this may be done over a network, such as the Internet or a Local Area Network (LAN).

As illustrated in FIG. 1, the decoder 112 may be implemented on electronic device B 102b separately from the encoder 104 on electronic device A 102a. However, it should be noted that the encoder 104 and decoder 112 may be implemented on the same electronic device in some configurations. In an implementation where the encoder 104 and decoder 112 are implemented on the same electronic device, for instance, the bitstream 114 may be provided over a bus to the decoder 112 or stored in memory for retrieval by the decoder 112.

The decoder 112 may be implemented in hardware, software or a combination of both. In one configuration, the decoder 112 may be an HEVC decoder. The decoder 112 may receive (e.g., obtain) the bitstream 114. The decoder 112 may generate one or more decoded pictures 118 based on the bitstream 114. The decoded picture(s) 118 may be displayed, played back, stored in memory and/or transmitted to another device, etc.

The decoder 112 may receive a message, such as a RAP picture message or a NAL unit header message having RAP picture information. The decoder 112 may also determine whether a RAP NAL unit type is present in the message. If a RAP NAL unit type is present in the message, then the decoder 112 may obtain a RAP information parameter from the message. The decoder 112 may decode a coded picture based on the RAP information parameter. For example, the coded picture may be a RAP picture.

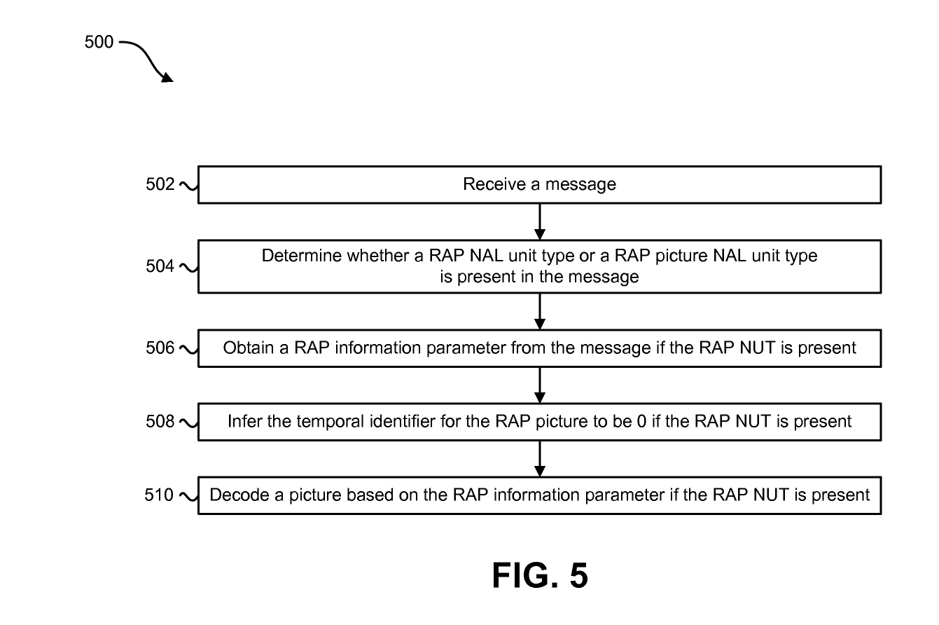

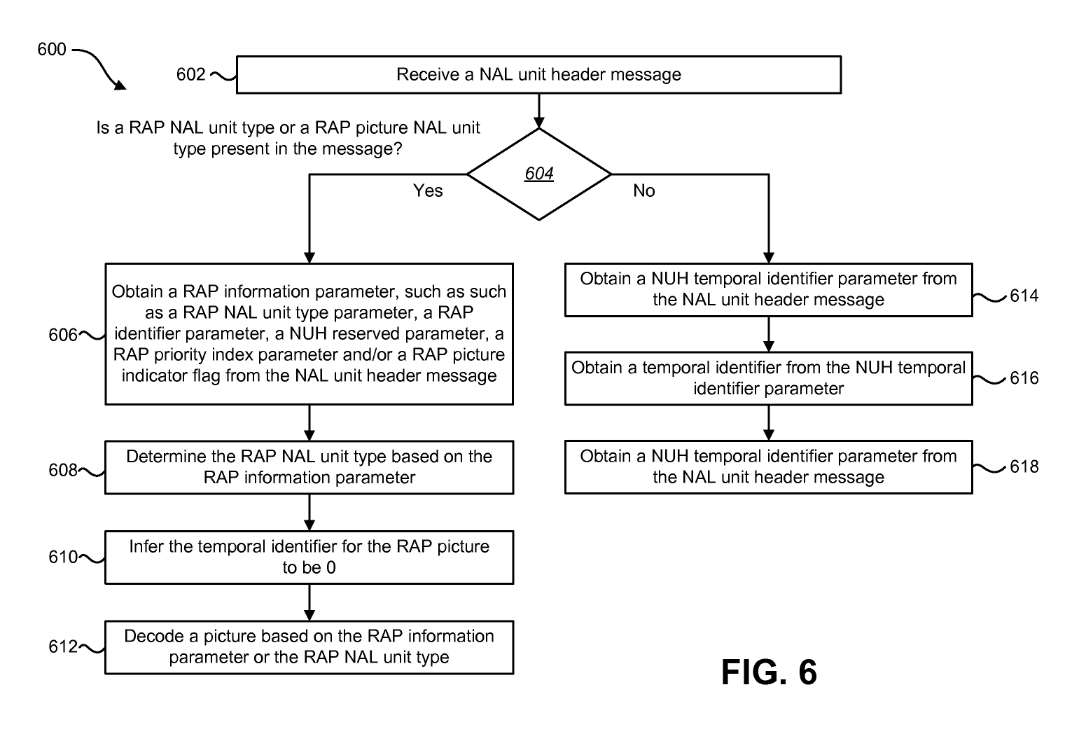

The decoder 112 may include a RAP picture message receiving module 120. The RAP picture message receiving module 120 may obtain RAP information corresponding to encoded pictures if a RAP NAL unit type or a RAP picture NAL unit type is present in the message. For instance, the RAP picture message receiving module 120 may perform one or more of the procedures described in connection with FIG. 5 and FIG. 6 below.

It should be noted that one or more of the elements or parts thereof included in the electronic device(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application specific integrated circuit (ASIC), a large scale integrated circuit (LSI) or integrated circuit, etc.

FIG. 2 is a flow diagram illustrating one configuration of a method 200 for sending a message. An electronic device 102 (e.g., electronic device A 102a) may determine 202 whether a picture is a random access point (RAP) picture. For example, the encoder 104 may encode an input picture 106 as a RAP picture. If the encoder 104 encodes an input picture 106 as a RAP picture, the electronic device 102 may determine 202 that a picture is a RAP picture. Otherwise, the electronic device 102 may determine that the picture is not a RAP picture.

The electronic device 102 may generate 204 a message (e.g., a RAP picture message, a NAL unit header message having RAP information or another message) including a RAP NUT and a RAP information parameter. For instance, the electronic device 102 may generate 204 a NAL unit header message having RAP information therein. For example, the NAL unit header message may include the NAL unit type RAP_NUT and the RAP information parameter rap_nal_unit_type. In some configurations, the RAP information parameter may indicate a NAL unit sub-type, which may be a RAP NAL unit type, as illustrated in Table 3 above.

The message may be generated 204 such that the message includes either a RAP information parameter or a NUH temporal identifier parameter (e.g., nuh_temperal_id_plus1). The RAP information parameter and the NUH temporal identifier parameter may occupy the same 3 bits in the bitstream 114. If the picture is a RAP picture, the electronic device 102 may generate a RAP information parameter in the message. Otherwise, the electronic device 102 may generate a NUH temporal identifier parameter in the message.

In some configurations, the message may be generated 204 for only some types of RAP pictures. For example, if the picture is an IDR or BLA picture (but not CRA picture), the electronic device 102 may generate 204 a RAP information parameter in the message. Otherwise, the electronic device 102 may generate a NUH temporal identifier parameter in the message.

The electronic device 102 may send 206 the message (e.g., a RAP picture message, a NAL unit header message having RAP information or another message). For example, the electronic device 102 may transmit the message via one or more of wireless transmission, wired transmission, device bus, network, etc. For instance, electronic device A 102a may transmit the message to electronic device B 102b. The message may be part of the bitstream 114, for example. In some configurations, electronic device A 102a may send 206 the message to electronic device B 102b in a separate transmission (not shown) that is not part of the bitstream 114. For example, the message may be sent using some out-of-band mechanism.

FIG. 3 is a flow diagram illustrating a more specific configuration of a method 300 for sending a message. An electronic device 102 (e.g., electronic device A 102a) may obtain an input picture. The input picture may be a RAP picture.

A RAP picture may be a BLA picture, an IDR picture or a CRA picture. In some configurations, a RAP picture may include one or more slices, where each slice has a nal_unit_type (e.g., network abstraction layer unit type) value equal to 7, as illustrated in Table 2 above. For example, the RAP picture may include one or more slices, where each slice has a nal_unit_type RAP NAL unit type (NUT) (e.g., RAP_NUT).

It should be noted that a RAP picture may occur in the bitstream 114. The RAP picture may be any picture in a stream of data (e.g., bitstream) where decoding of the bitstream does not require access to any picture in a bitstream preceding the RAP picture to decode a current picture and all pictures subsequent to said current picture in output order.

The electronic device 102 may determine 304 whether a picture is a RAP picture. This may be accomplished as described in connection with FIG. 2 above. In some cases, the electronic device 102 may determine 304 whether a picture is a certain type of RAP picture, such as if the picture is an IDR or BLA picture (but not CRA picture).

If the picture is a RAP picture, the electronic device 102 may generate 306 a NAL unit header message including a RAP NUT. The NAL unit header message may be generated such that the NAL unit header message does not include a NUH temporal identifier parameter (e.g., nuh_temperal_id_plus1) if the picture is a RAP picture. In this manner, the electronic device 102 may employ the same 3 bits that would have been used for the NUH temporal identifier parameter to signal a RAP information parameter. In other words, the RAP information parameter may replace NUH temporal identifier parameter in the bitstream when the picture is a RAP picture.

If the picture is a RAP picture, the electronic device 102 may include 308 a RAP information parameter in the NAL unit header message. In one configuration, the RAP information parameter may be a RAP NAL unit type parameter (e.g., rap_nal_unit_type) and may specify a RAP NAL unit type (e.g., a NAL unit sub-type). The RAP information parameter may specify a RAP NAL unit type as described in Table 3 above. For example, the RAP information parameter may specify that a RAP picture has a BLA with LP RAP NAL unit type (e.g., BLA_W_LP), a BLA with DLP RAP NAL unit type (e.g., BLA_W_DLP), a BLA with no LP RAP NAL unit type (e.g., BLA_N_LP), an IDR with DLP RAP NAL unit type (e.g., IDR_W_DLP), an IDR with no LP RAP NAL unit type (e.g., IDR_N_LP) or a CRA NUT RAP NAL unit type (e.g., CRA_NUT).

In another configuration, the RAP information parameter may be a RAP identifier parameter (e.g., rap_id). The RAP identifier parameter may identify a RAP picture and may increment by 1 each time a new RAP picture is sent in the bitstream 114. The RAP information parameter may assist in distinguishing picture slices that are mixed, that arrive out of order or get lost. For example, the values of RAP identifier may be the same for all slices of a RAP picture. Then, for the next RAP picture, the value of the RAP identifier may be incremented for all slices of that RAP picture. In this manner, back-to-back RAP pictures may be distinguishable.

In yet other configurations, the RAP information parameter may be a NUH reserved parameter (e.g., nuh_reserved_one_{—}3bits or nuh_reserved_zero_{—}3bits), a RAP priority index parameter (e.g., priority_idx) and/or a RAP picture indicator flag (e.g., no_output_of prior_pics_flag). The priority index may indicate the priority of the RAP NAL unit of a RAP picture. For example, RAP priority may be used for determining which RAP picture is more important in terms of distortion reduction.

The RAP picture indicator flag may signal a RAP picture. For example, the RAP picture indicator flag may be a single bit flag indicating no output of prior pictures. In some configurations, the RAP picture indicator flag may be signaled in the slice header or the PPS and may use one of the 3 bits allocated for nuh_temporal_id_plus1 when the picture is a RAP picture.

If the picture is a non-RAP picture, the electronic device 102 may generate 312 a NAL unit header NUH temporal identifier parameter, such as nuh_temporal_id_plus1, in the NAL unit header message. The NUH temporal identifier parameter may specify the temporal id of a corresponding non-RAP picture.

The electronic device 102 may send 310 the NAL unit header message. For example, the electronic device 102 may transmit the NAL unit header message via one or more of wireless transmission, wired transmission, device bus, network, etc. For instance, electronic device A 102a may transmit the NAL unit header message to electronic device B 102b. The NAL unit header message may be sent inside a NAL unit. The NAL unit may include the coded slice data of the RAP picture following the NAL unit header message. The NAL unit header message may be part of the bitstream 114, for example.

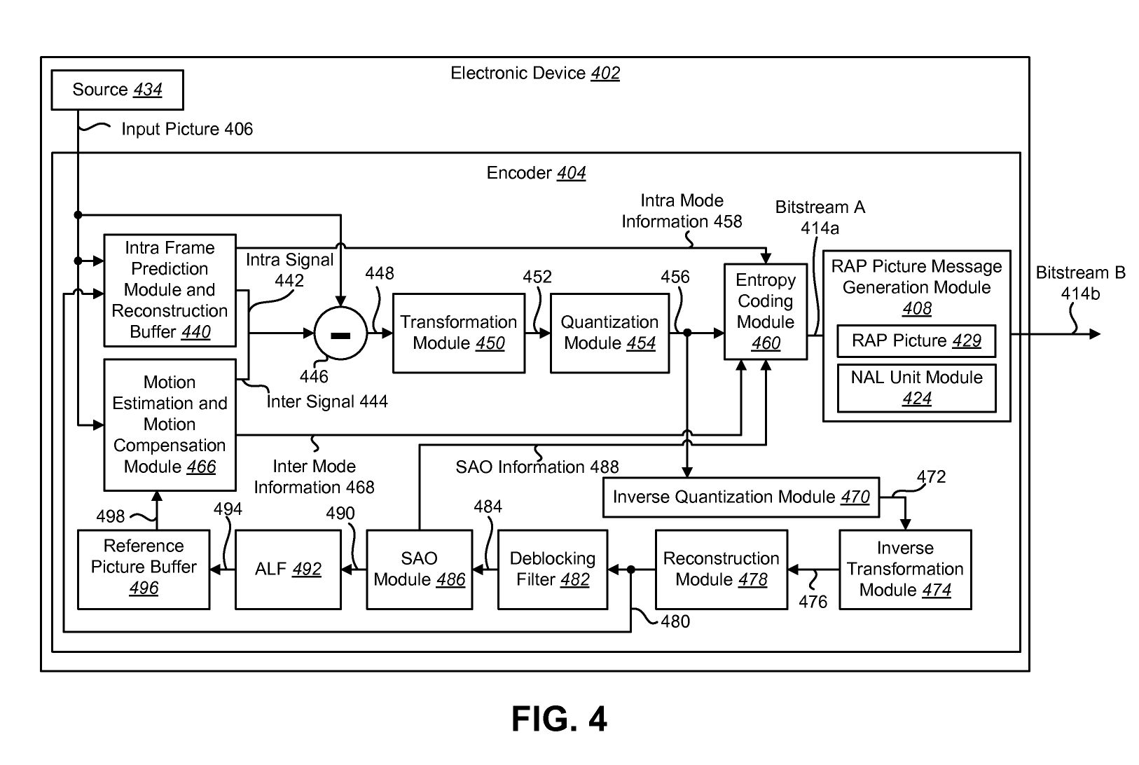

FIG. 4 is a block diagram illustrating one configuration of an encoder 404 on an electronic device 402. It should be noted that one or more of the elements illustrated as included within the electronic device 402 may be implemented in hardware, software or a combination of both. For example, the electronic device 402 includes an encoder 404, which may be implemented in hardware, software or a combination of both. For instance, the encoder 404 may be implemented as a circuit, integrated circuit, application specific integrated circuit (ASIC), processor in electronic communication with memory with executable instructions, firmware, field-programmable gate array (FPGA), etc., or a combination thereof. In some configurations, the encoder 404 may be an HEVC coder.

The electronic device 402 may include a source 434. The source 434 may provide picture or image data (e.g., video) as an input picture 406 to the encoder 404. Examples of the source 434 may include image sensors, memory, communication interfaces, network interfaces, wireless receivers, ports, etc.

One or more input pictures 406 may be provided to an intra frame prediction module and reconstruction buffer 440. An input picture 406 may also be provided to a motion estimation and motion compensation module 466 and to a subtraction module 446.

The intra frame prediction module and reconstruction buffer 440 may generate intra mode information 458 and an intra signal 442 based on one or more input pictures 406 and reconstructed data 480. The motion estimation and motion compensation module 466 may generate inter mode information 468 and an inter signal 444 based on one or more input pictures 406 and a reference picture buffer 496 reference picture buffer output signal 498. In some configurations, the reference picture buffer 496 may include data from one or more reference pictures in the reference picture buffer 496.

The encoder 404 may select between the intra signal 442 and the inter signal 444 in accordance with a mode. The intra signal 442 may be used in order to exploit spatial characteristics within a picture in an intra coding mode. The inter signal 444 may be used in order to exploit temporal characteristics between pictures in an inter coding mode. While in the intra coding mode, the intra signal 442 may be provided to the subtraction module 446 and the intra mode information 458 may be provided to an entropy coding module 460. While in the inter coding mode, the inter signal 444 may be provided to the subtraction module 446 and the inter mode information 468 may be provided to the entropy coding module 460.

Either the intra signal 442 or the inter signal 444 (depending on the mode) is subtracted from an input picture 406 at the subtraction module 446 in order to produce a prediction residual 448. The prediction residual 448 is provided to a transformation module 450. The transformation module 450 may compress the prediction residual 448 to produce a transformed signal 452 that is provided to a quantization module 454. The quantization module 454 quantizes the transformed signal 452 to produce transformed and quantized coefficients (TQCs) 456.

The TQCs 456 are provided to an entropy coding module 460 and an inverse quantization module 470. The inverse quantization module 470 performs inverse quantization on the TQCs 456 to produce an inverse quantized signal 472 that is provided to an inverse transformation module 474. The inverse transformation module 474 decompresses the inverse quantized signal 472 to produce a decompressed signal 476 that is provided to a reconstruction module 478.

The reconstruction module 478 may produce reconstructed data 480 based on the decompressed signal 476. For example, the reconstruction module 478 may reconstruct (modify) pictures. The reconstructed data 480 may be provided to a deblocking filter 482 and to the intra prediction module and reconstruction buffer 440. The deblocking filter 482 may produce a filtered signal 484 based on the reconstructed data 480.

The filtered signal 484 may be provided to a sample adaptive offset (SAO) module 486. The SAO module 486 may produce SAO information 488 that is provided to the entropy coding module 460 and an SAO signal 490 that is provided to an adaptive loop filter (ALF) 492. The ALF 492 produces an ALF signal 494 that is provided to the reference picture buffer 496. The ALF signal 494 may include data from one or more pictures that may be used as reference pictures.

The entropy coding module 460 may code the TQCs 456 to produce a bitstream 414 or other signal. Also, the entropy coding module 460 may code the TQCs 456 using context-adaptive variable length coding (CAVLC) or context-adaptive binary arithmetic coding (CABAC). In particular, the entropy coding module 460 may code the TQCs 456 based on one or more of intra mode information 458, inter mode information 468 and SAO information 488. Bitstream A 414a (e.g., encoded picture data) may be provided to a RAP picture message generation module 408.

The RAP picture message generation module 408 may be configured similarly to the RAP picture message generation module 108 described in connection with FIG. 1. Additionally or alternatively, the RAP picture message generation module 408 may perform one or more of the procedures described in connection with FIG. 2 and FIG. 3. For example, the RAP picture message generation module 408 may include a RAP picture 429. The RAP picture message generation module 408 may further include a variety of modules or sub-modules for generating one or more RAP picture messages. For example, the RAP picture message generation module 408 may include a NAL unit module.

In some configurations, a NAL unit module 424 may generate a single NAL unit and a set of RAP NAL units to be used for decoding the coded RAP picture 429. For example, the NAL unit module 424 may associate NAL units with type values of 7, as shown in Table 2 above, with a RAP picture 429. The NAL unit module 424 may also associate RAP NAL unit types to be used for decoding the coded RAP picture 429, as shown in Table 3, above. For example, the NAL unit module 424 may associate RAP NAL units with type values of 1-6 with a coded RAP picture 429.

The RAP picture message generation module 408 may generate a message, such as a RAP picture message, a NAL unit header message having RAP picture information or another message. The generated message may include a RAP NAL unit type parameter (e.g., rap_nal_unit_type), a RAP identifier parameter (e.g., rap_id), a NUH reserved parameter (e.g., nuh_reserved_one_{—}3bits or nuh_reserved_zero_{—}3bits), a RAP priority index parameter (e.g., priority_idx) and/or a RAP picture indicator flag (e.g., no_output_of prior_pics_flag) if a picture (in the bitstream 414a, for example) is a RAP picture (e.g., a picture having a NAL unit type equal to RAP_NUT).

In some configurations, the message may be inserted into bitstream A 414a to produce bitstream B 414b. Thus, the message may be generated after the entire bitstream A 414a is generated (e.g., after most of bitstream B 414b is generated), for example. In other configurations, the message may not be inserted into bitstream A 414a (in which case bitstream B 414b may be the same as bitstream A 414a), but may be provided in a separate transmission (not shown).

In some configurations, the electronic device 402 sends the bitstream 414 to another electronic device. For example, the bitstream 414 may be provided to a communication interface, network interface, wireless transmitter, port, etc. For instance, the bitstream 414 may be transmitted to another electronic device via LAN, the Internet, a cellular phone base station, etc. The bitstream 414 may additionally or alternatively be stored in memory or other component on the electronic device 402.

FIG. 5 is a flow diagram illustrating one configuration of a method 500 for receiving a message. An electronic device 102 (e.g., electronic device B 102b) may receive 502 a message (e.g., a RAP picture message, a NAL unit header message having RAP information or another message). For example, the electronic device 102 may receive 502 the message via one or more of wireless transmission, wired transmission, device bus, network, etc. For instance, electronic device B 102b may receive 502 the message from electronic device A 102a. The message may be part of the bitstream 114, for example. In another example, electronic device B 102b may receive the message from electronic device A 102a in a separate transmission (not shown) that is not part of the bitstream 114, for example. In some configurations, the message may include the NAL unit type RAP_NUT and the RAP information parameter rap_nal_unit_type. Thus, receiving 502 the message may include receiving a RAP NUT and a RAP information parameter. In other cases, receiving 502 the message may include receiving the individual RAP NAL unit types, such as a BLA_W_LP, BLA_W_DLP, BLA_N_LP, IDR_W_DLP, IDR_N_LP or CRA_NUT NAL unit type and a RAP information parameter.

The electronic device 102 may determine 504 whether a RAP NAL unit type (NUT) or a RAP picture NAL unit type is present in the message. For example, the message may include the RAP NAL unit type RAP_NUT. The RAP NUT may indicate a nal_unit_type with a value equal to 7 and may indicate that the message corresponds to a coded RAP picture. As another example, message may indicate a RAP picture NAL unit type as a BLA_W_LP, BLA_W_DLP, BLA_N_LP, IDR_W_DLP, IDR_N_LP or CRA_NUT NAL unit type. If a RAP NUT is not present in the message, the electronic device 102 may determine that a RAP NUT is not present in the message and that the corresponding picture is not a RAP picture.

If a RAP NUT is present in the message, the electronic device 102 may obtain 506 a RAP information parameter from the message. For example, the RAP information parameter may be rap_nal_unit_type. In some configurations, the RAP information parameter may indicate a NAL unit sub-type, which may be a RAP NAL unit type, as illustrated in Table 3 above.

It should be noted that if a RAP NUT is present in the message, then the message does not include a NUH temporal identifier parameter (e.g., nuh_temperal_id_plus1). This may be because the RAP information parameter and the NUH temporal identifier parameter may occupy the same 3 bits in the message and in the bitstream 114.

If a RAP NUT is present in the message, the electronic device 102 may infer 508 the temporal identifier for the RAP picture to be 0. For example, the TemporalId value may be automatically inferred and set to 0 if a RAP NUT is present in the message.

If a RAP NUT is present in the message, the electronic device 102 may decode 510 a picture based on the RAP information parameter. For example, the electronic device 102 may decode 510 an encoded picture received in the bitstream 114.

FIG. 6 is a flow diagram illustrating a more specific configuration of a method 600 for receiving a message. An electronic device 102 (e.g., electronic device B 102b) may receive 602 a NAL unit header message. This may be accomplished as described above in connection with FIG. 5, for example.

The electronic device 102 may determine 604 whether a RAP NAL unit type (NUT) or a RAP picture NAL unit type is present in the message. This may be accomplished as described above in connection with FIG. 5, for example.

If a RAP NUT is present in the NAL unit header message, the electronic device 102 may obtain 606 a RAP information parameter from the NAL unit header message. In one configuration, electronic device 102 may obtain 606 a RAP NAL unit type parameter (e.g., rap_nal_unit_type). In some configurations, if the RAP information parameter is a RAP NAL unit type parameter, the electronic device 102 may optionally determine 608 the RAP NAL type based on the RAP information parameter. For example, the RAP NAL unit type parameter may specify a RAP NAL unit type (e.g., a NAL unit sub-type) as illustrated in Table 3 above. For instance, the RAP information parameter may specify that a RAP picture has a BLA with LP RAP NAL unit type (e.g., BLA_W_LP), a BLA with DLP RAP NAL unit type (e.g., BLA_W_DLP), a BLA with no LP RAP NAL unit type (e.g., BLA_N_LP), an IDR with DLP RAP NAL unit type (e.g., IDR_W_DLP), an IDR with no LP RAP NAL unit type (e.g., IDR_N_LP) or a CRA NUT RAP NAL unit type (e.g., CRA_NUT).

In another configuration, if a NAL unit type for a RAP picture (e.g., BLA_W_LP, BLA_W_DLP, BLA_N_LP, IDR_W_DLP, IDR_N_LP or CRA) is present in the NAL unit header message, the electronic device 102 may obtain 606 a RAP identifier parameter (e.g., rap_id). The RAP identifier parameter may identify a RAP picture and may increment by 1 each time a new RAP picture is received in the bitstream 114. The RAP information parameter may assist in distinguishing picture slices that are mixed or that arrive out of order.

In yet other configurations, if a NAL unit type for a RAP picture (e.g., BLA_W_LP, BLA_W_DLP, BLA_N_LP, IDR_W_DLP, IDR_N_LP or CRA) is present in the NAL unit header message, the electronic device 102 may obtain 606 a NUH reserved parameter (e.g., nuh_reserved_one_{—}3bits or nuh_reserved_zero_{—}3bits), a RAP priority index parameter (e.g., priority_idx) and/or a RAP picture indicator flag (e.g., no_output_of prior_pics_flag). The priority index may indicate the priority of the NAL unit of a RAP picture. For example, RAP priority may be used for determining which RAP picture is more important in terms of distortion reduction.

The RAP picture indicator flag may signal a RAP picture. For example, the RAP picture indicator flag may be a single bit flag indicating no output of prior pictures. In some configurations, the RAP picture indicator flag may be received in the slice header or the PPS and may use one of the 3 bits allocated for nuh_temporal_id_plus1 when a received picture is a coded RAP picture.

If a RAP NUT is present in the message, the electronic device 102 may infer 610 the temporal identifier for the RAP picture to be 0. For example, the TemporalId value may be automatically inferred and set to 0 if a RAP NUT is present in the message.

If a RAP NUT is present in the NAL unit header message, the electronic device 102 may decode 612 a picture based on the RAP information parameter or the RAP NAL unit type. For example, the electronic device 102 may use the RAP identifier parameter, RAP NAL unit type (e.g., NAL unit sub-type), to determine the specific RAP NAL unit type decode and encoded RAP picture.

If the electronic device 102 determines 604 that a RAP NUT or a RAP picture NAL unit type is not present in the NAL unit header message, the electronic device 102 may obtain 614 a NUH temporal identifier parameter, such as nuh_temperal_id_plus1, from the NAL unit header message. In other words, if the picture corresponding to the NAL unit header is a RAP picture, the electronic device 102 may obtain 606 a RAP information parameter. If, however, if the picture corresponding to the NAL unit header is not a RAP picture, the electronic device 102 may obtain 614 a NUH temporal identifier parameter. This may be because the RAP information parameter and the NUH temporal identifier parameter may occupy the same 3 bits in the message and in the bitstream 114.

If a RAP NUT is not present in the NAL unit header message, the electronic device 102 may obtain 616 the temporal identifier for the non-RAP. For example, the TemporalId value for the non-RAP picture may be 0, 1, 3 . . . , n, etc. when n is a positive integer.

If a RAP NUT is not present in the NAL unit header message, the electronic device 102 may decode 618 a non-RAP picture based on the NUH temporal identifier parameter. For example, the NUH temporal identifier parameter may specify the temporal id of a corresponding non-RAP picture, which may assist the electronic device 102 in decoding a non-RAP picture.

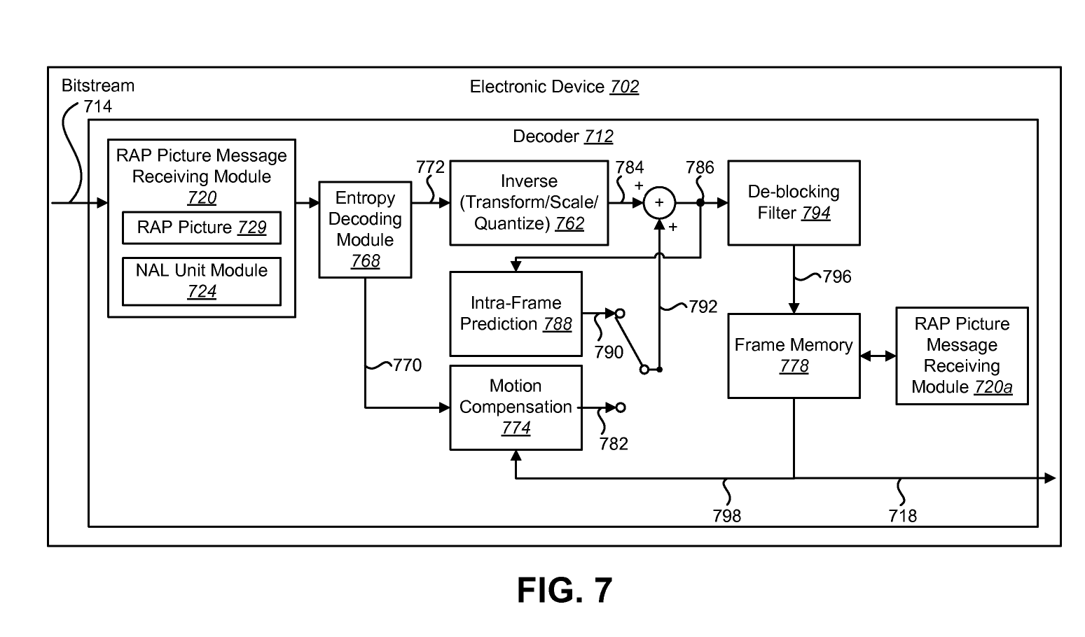

FIG. 7 is a block diagram illustrating one configuration of a decoder 712 on an electronic device 702. The decoder 712 may be included in an electronic device 702. For example, the decoder 712 may be an HEVC decoder. The decoder 712 and one or more of the elements illustrated as included in the decoder 712 may be implemented in hardware, software or a combination of both. The decoder 712 may receive a bitstream 714 (e.g., one or more encoded pictures and overhead data included in the bitstream 714) for decoding.

In some configurations, the received bitstream 714 may include received overhead data, such as a message (e.g., a RAP picture message, a NAL unit header message having RAP picture information), slice header, PPS, etc. In some configurations, the decoder 712 may additionally receive a separate transmission (not shown). The separate transmission may include a message (e.g., a RAP picture message, a NAL unit header message having RAP picture information or other message). For example, a RAP picture message or a NAL unit header message having RAP picture information may be received in a separate transmission instead of in the bitstream 714. However, it should be noted that the separate transmission may be optional and may not be utilized in some configurations.

The decoder 712 may include a RAP picture message receiving module 720. In some configurations, the electronic device 702 receives a bitstream 714 and sends the bitstream 714 through the RAP picture message receiving module 720.

The RAP picture message receiving module 720 may be configured similarly to the RAP picture message receiving module 120 described in connection with FIG. 1 above. Additionally or alternatively, the decoder 712 may perform one or more of the procedures described in connection with FIG. 5 and FIG. 6. For example, the decoder 712 may receive a message (e.g., a RAP picture message, a NAL unit header message having RAP picture information). Additionally, the decoder 712 may determine whether a RAP NAL unit type or a RAP picture NAL unit type is present in the message. Alternatively, the decoder 712 may determine if a NAL unit type for a RAP picture (e.g., BLA_W_LP, BLA_W_DLP, BLA_N_LP, IDR_W_DLP, IDR_N_LP or CRA) is present in the message. If a RAP NAL unit type or if a RAP NAL unit type or a RAP picture NAL unit type is present in the message, then the decoder 712 may obtain a RAP information parameter from the message. The decoder 712 may decode a coded picture based on the RAP information parameter. For example, the coded picture may be a RAP picture 729.

The RAP picture message receiving module 720 may be part of a decoder 712 or other components on the electronic device 702. The RAP picture message receiving module 720 may receive one or more messages (e.g., a RAP picture message or a NAL unit header message having RAP picture information) at the electronic device 702. The messages may also provide RAP picture information employed in decoding an encoded RAP picture.

The RAP picture message receiving module 720 may include a variety of modules or sub-modules for receiving one or more RAP picture messages from the bitstream 714. For example, the RAP picture message receiving module 720 may include a NAL unit module 724 or other modules, for RAP picture messages from the bitstream 714, prior to passing through certain elements of the decoder 712. The RAP picture message receiving module 720 may also include a RAP picture 729. The RAP picture 729 may be received as an encoded picture and may be decoded by the decoder 712.

In some configurations, the NAL unit module 724 may assist the decoder 712 in obtaining NAL unit types and RAP NAL unit types from the bitstream 714. For example, a NAL unit (e.g., RAP_NUT) may be associated with a RAP picture 729. In addition, a set of RAP NAL units, as shown in Table 3, may be associated with the RAP picture 729. For example, the NAL unit module 724 may receive the set of RAP NAL units and provide the RAP NAL unit type to the decoder 712. For instance, the NAL unit module 724 may obtain RAP NAL units with type values of 1-6 (as shown in Table 3 above) in connection with a received coded RAP picture 729.

The RAP picture message receiving module 720 may provide encoded picture data to an entropy decoding module 768. For instance, the encoded data may be RAP picture information data corresponding to a RAP picture 729. The encoded picture data may be entropy decoded by an entropy decoding module 768, thereby producing a motion information signal 770 and quantized, scaled and/or transformed coefficients 772.

The motion information signal 770 may be combined with a portion of a reference frame signal 798 from a frame memory 778 at a motion compensation module 774, which may produce an inter frame prediction signal 782. The quantized, descaled and/or transformed coefficients 772 may be inverse quantized, scaled and inverse transformed by an inverse module 762, thereby producing a decoded residual signal 784. The decoded residual signal 784 may be added to a prediction signal 792 to produce a combined signal 786. The prediction signal 792 may be a signal selected from the inter frame prediction signal 782 produced the motion compensation module 774 or alternatively the intra frame prediction signal 790 produced by an intra frame prediction module 788. In some configurations, this signal selection may be based on (e.g., controlled by) the bitstream 714.

The intra frame prediction signal 790 may be predicted from previously decoded information from the combined signal 786 (in the current frame, for example). The combined signal 786 may also be filtered by a de-blocking filter 794. The resulting filtered signal 796 may be written to frame memory 778. The resulting filtered signal 796 may include a decoded picture.

The frame memory 778 may include overhead information corresponding to the decoded pictures. For example, the frame memory 778 may include slice headers, parameter information, cycle parameters, buffer description information, etc. One or more of these pieces of information may be signaled from an encoder (e.g., encoder 104). The frame memory 778 may provide a decoded picture 718 or other output signal.

In some configurations, the decoder 712 may include a RAP picture message receiving module 720a in communication with the frame memory 778. For example, the frame memory 778 may provide and/or retrieve a decoded RAP picture 729 to the RAP picture message receiving module 720.

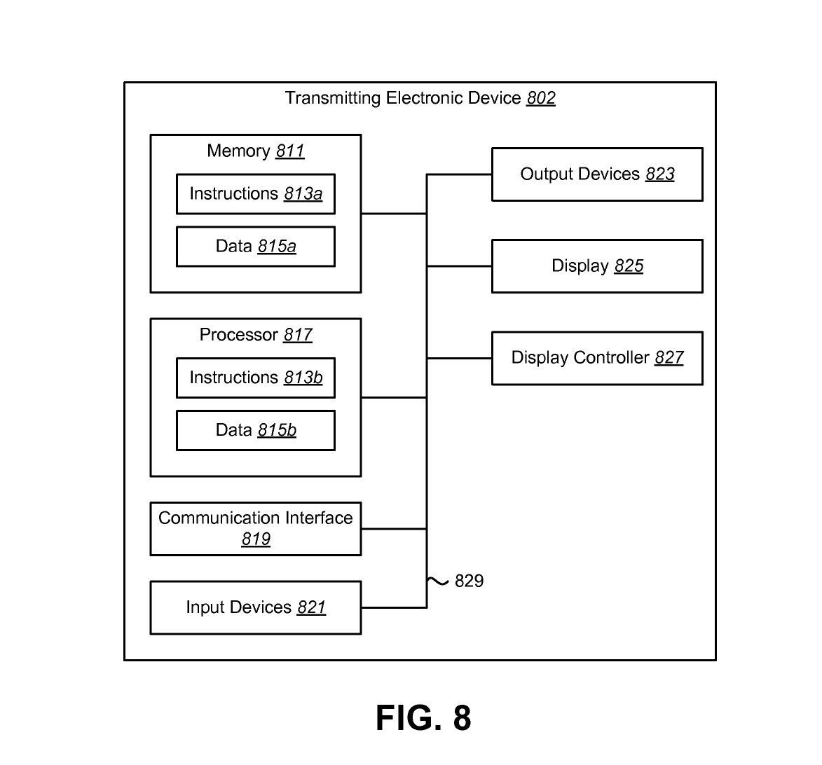

FIG. 8 illustrates various components that may be utilized in a transmitting electronic device 802. One or more of the electronic devices 102, 402, 702 described herein may be implemented in accordance with the transmitting electronic device 802 illustrated in FIG. 8.

The transmitting electronic device 802 includes a processor 817 that controls operation of the electronic device 802. The processor 817 may also be referred to as a CPU. Memory 811, which may include both read-only memory (ROM), random access memory (RAM) or any type of device that may store information, provides instructions 813a (e.g., executable instructions) and data 815a to the processor 817. A portion of the memory 811 may also include non-volatile random access memory (NVRAM). The memory 811 may be in electronic communication with the processor 817.

Instructions 813b and data 815b may also reside in the processor 817. Instructions 813b and/or data 815b loaded into the processor 817 may also include instructions 813a and/or data 815a from memory 811 that were loaded for execution or processing by the processor 817. The instructions 813b may be executed by the processor 817 to implement the systems and methods disclosed herein. For example, the instructions 813b may be executable to perform one or more of the methods 200, 300, 500, 600 described above.

The transmitting electronic device 802 may include one or more communication interfaces 819 for communicating with other electronic devices (e.g., receiving electronic device). The communication interfaces 819 may be based on wired communication technology, wireless communication technology, or both. Examples of a communication interface 819 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, a wireless transceiver in accordance with 3rd Generation Partnership Project (3GPP) specifications and so forth.

The transmitting electronic device 802 may include one or more output devices 823 and one or more input devices 821. Examples of output devices 823 include a speaker, printer, etc. One type of output device 823 that may be included in an electronic device 802 is a display device 825. Display devices 825 used with configurations disclosed herein may utilize any suitable image projection technology, such as a cathode ray tube (CRT), liquid crystal display (LCD), light-emitting diode (LED), gas plasma, electroluminescence or the like. A display controller 827 may be provided for converting data stored in the memory 811 into text, graphics, and/or moving images (as appropriate) shown on the display 825. Examples of input devices 821 include a keyboard, mouse, microphone, remote control device, button, joystick, trackball, touchpad, touchscreen, lightpen, etc.

The various components of the transmitting electronic device 802 are coupled together by a bus system 829, which may include a power bus, a control signal bus and a status signal bus, in addition to a data bus. However, for the sake of clarity, the various buses are illustrated in FIG. 8 as the bus system 829. The transmitting electronic device 802 illustrated in FIG. 8 is a functional block diagram rather than a listing of specific components.

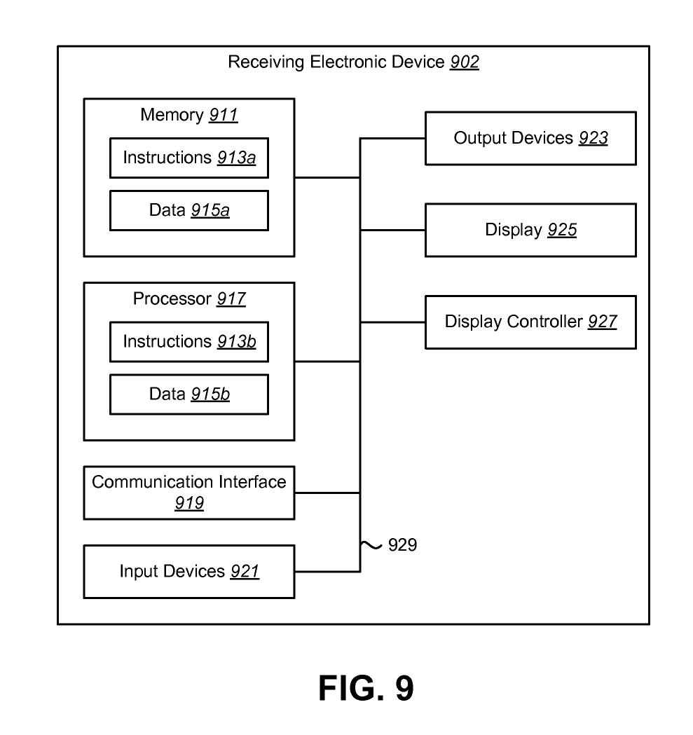

FIG. 9 is a block diagram illustrating various components that may be utilized in a receiving electronic device 902. One or more of the electronic devices 102, 402, 702 described herein may be implemented in accordance with the receiving electronic device 902 illustrated in FIG. 9.

The receiving electronic device 902 includes a processor 917 that controls operation of the electronic device 902. The processor 917 may also be referred to as a central processing unit (CPU). Memory 911, which may include both read-only memory (ROM), random access memory (RAM) or any type of device that may store information, provides instructions 913a (e.g., executable instructions) and data 915a to the processor 917. A portion of the memory 911 may also include non-volatile random access memory (NVRAM). The memory 911 may be in electronic communication with the processor 917.

Instructions 913b and data 915b may also reside in the processor 917. Instructions 913b and/or data 915b loaded into the processor 917 may also include instructions 913a and/or data 915a from memory 911 that were loaded for execution or processing by the processor 917. The instructions 913b may be executed by the processor 917 to implement the systems and methods disclosed herein. For example, the instructions 913b may be executable to perform one or more of the methods 200, 300, 600, 600 described above.

The receiving electronic device 902 may include one or more communication interfaces 919 for communicating with other electronic devices (e.g., a transmitting electronic device). The communication interface 919 may be based on wired communication technology, wireless communication technology, or both. Examples of a communication interface 919 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, a wireless transceiver in accordance with 3rd Generation Partnership Project (3GPP) specifications and so forth.

The receiving electronic device 902 may include one or more output devices 923 and one or more input devices 921. Examples of output devices 923 include a speaker, printer, etc. One type of output device that may be included in an electronic device 902 is a display device 925. Display devices 925 used with configurations disclosed herein may utilize any suitable image projection technology, such as a cathode ray tube (CRT), liquid crystal display (LCD), light-emitting diode (LED), gas plasma, electroluminescence or the like. A display controller 927 may be provided for converting data stored in the memory 911 into text, graphics, and/or moving images (as appropriate) shown on the display 925. Examples of input devices 921 include a keyboard, mouse, microphone, remote control device, button, joystick, trackball, touchpad, touchscreen, lightpen, etc.

The various components of the receiving electronic device 902 are coupled together by a bus system 929, which may include a power bus, a control signal bus and a status signal bus, in addition to a data bus. However, for the sake of clarity, the various buses are illustrated in FIG. 9 as the bus system 929. The receiving electronic device 902 illustrated in FIG. 9 is a functional block diagram rather than a listing of specific components.

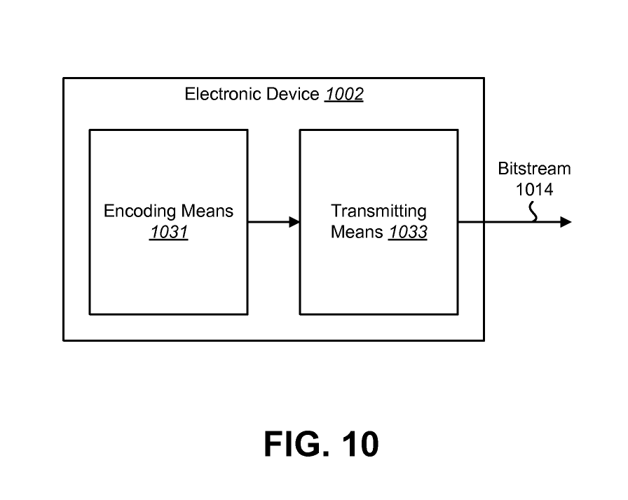

FIG. 10 is a block diagram illustrating one configuration of an electronic device 1002 in which systems and methods for sending a message may be implemented. The electronic device 1002 includes encoding means 1031 and transmitting means 1033. The encoding means 1031 and transmitting means 1033 may be configured to perform one or more of the functions described in connection with one or more of FIG. 1, FIG. 2, FIG. 3, FIG. 4 and FIG. 8 above. For example, the encoding means 1031 and transmitting means 1033 may generate a bitstream 1014. FIG. 8 above illustrates one example of a concrete apparatus structure of FIG. 10. Other various structures may be implemented to realize one or more of the functions of FIG. 1, FIG. 2, FIG. 3, FIG. 4 and FIG. 8. For example, a DSP may be realized by software.

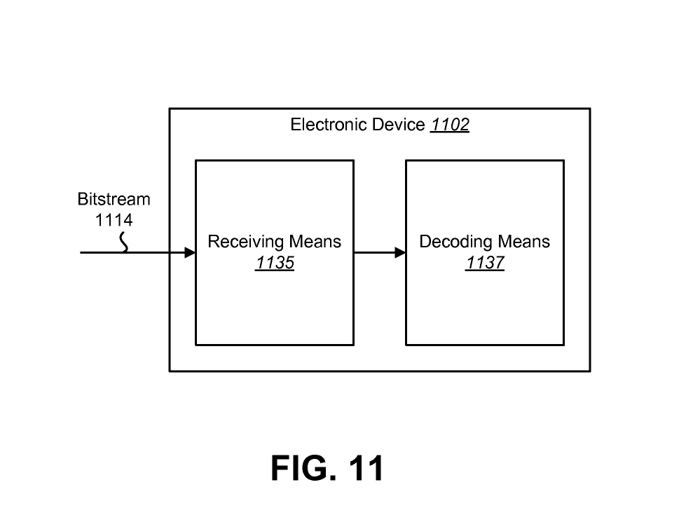

FIG. 11 is a block diagram illustrating one configuration of an electronic device 1102 in which systems and methods for buffering a bitstream 1114 may be implemented. The electronic device 1102 may include receiving means 1135 and decoding means 1137. The receiving means 1135 and decoding means 1137 may be configured to perform one or more of the functions described in connection with one or more of FIG. 1, FIG. 5, FIG. 6, FIG. 7 and FIG. 9 above. For example, the receiving means 1135 and decoding means 1137 may receive a bitstream 1114. FIG. 9 above illustrates one example of a concrete apparatus structure of FIG. 11. Other various structures may be implemented to realize one or more functions of FIG. 1, FIG. 5, FIG. 6, FIG. 7 and FIG. 9. For example, a DSP may be realized by software.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can carry or store desired program code in the form of instructions or data structures and that can be accessed by a computer or processor. Disk and disc, as used herein, include compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods or approaches described herein may be implemented in and/or realized using a chipset, an ASIC, a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. An electronic device for sending a message, comprising:
a processor;
memory in electronic communication with the processor;
instructions stored in the memory, the instructions being executable to:
determine whether a picture is a random access point (RAP) picture, and if the picture is a RAP picture:
generate a message including one of a RAP network access layer (NAL) unit type (NUT) and a RAP picture NAL unit type, and a RAP information parameter, wherein the message does not include a NAL unit header (NUH) temporal identifier parameter; and
send the message.

2. The electronic device of claim 1, wherein the RAP NUT is the only NAL unit type to indicate a RAP NAL unit type.

3. The electronic device of claim 1, wherein the RAP NUT is RAP_NUT.

4. The electronic device of claim 1, wherein the RAP NUT value equals 7.

5. The electronic device of claim 1, wherein the RAP information parameter specifies a RAP NAL unit type as one of a broken link access (BLA) with leading pictures (LP), a BLA with decodable leading pictures (DLP), a BLA with no leading pictures (LP), an instantaneous decoding refresh (IDR) with DLP, an IDR with no leading pictures (LP), and a clean random access (CRA) NUT.

6. The electronic device of claim 5, wherein the BLA with LP RAP NAL unit type is BLA_W_LP, the BLA with DLP RAP NAL unit type is BLA_W_DLP, the BLA with no LP RAP NAL unit type is BLA_N_LP, the IDR with DLP RAP NAL unit type is IDR_W_DLP, the IDR with no LP RAP NAL unit type is IDR_N_LP, and the CRA NUT RAP NAL unit type is CRA_NUT.

7. The electronic device of claim 1, wherein the RAP information parameter is rap_nal_unit_type.

8. The electronic device of claim 1, wherein the RAP information parameter is 3 bits, and wherein the RAP information parameter is signaled using the same bits in the message as a nuh_temporal_id_plus1 parameter.

9. An electronic device for receiving a message, comprising:
a processor;
memory in electronic communication with the processor;
instructions stored in the memory, the instructions being executable to:
receive a message; and
determine whether one of a RAP network access layer (NAL) unit type (NUT) and a RAP picture NAL unit type is present in the message and if true:
obtain a RAP information parameter from the message; and
decode a picture based on the RAP information parameter.

10. The electronic device of claim 9, wherein the RAP NUT is the only NAL unit type to indicate a RAP NAL unit type.

11. The electronic device of claim 9, wherein the RAP NUT is RAP_NUT.

12. The electronic device of claim 9, wherein the RAP NUT value equals 7.

13. The electronic device of claim 9, wherein the RAP information parameter specifies a RAP NAL unit type as one of a broken link access (BLA) with leading pictures (LP), a BLA with decodable leading pictures (DLP), a BLA with no LP, an instantaneous decoding refresh (IDR) with DLP, an IDR with no LP, and a clean random access (CRA) NUT.

14. The electronic device of claim 13, wherein the BLA with LP RAP NAL unit type is BLA_W_LP, the BLA with DLP RAP NAL unit type is BLA_W_DLP, the BLA with no LP RAP NAL unit type is BLA_N_LP, the IDR with DLP RAP NAL unit type is IDR_W_DLP, the IDR with no LP RAP NAL unit type is IDR_N_LP, and the CRA NUT RAP NAL unit type is CRA_NUT.

15. The electronic device of claim 9, wherein the RAP information parameter is rap_nal_unit_type.

16. The electronic device of claim 9, wherein the RAP information parameter is 3 bits, and wherein the RAP information parameter is signaled using the same bits in the message as a nuh_temporal_id_plus1 parameter.

17. A method for receiving a message, comprising:
receiving a message; and
determining whether one of a RAP network access layer (NAL) unit type (NUT) and a RAP picture NAL unit type is present in the message, and if true:
obtaining a RAP information parameter from the message; and
decoding a picture based on the RAP information parameter.

18. The method of claim 17, wherein the RAP NUT is the only NAL unit type to indicate a RAP NAL unit type.

19. The method of claim 17, wherein the RAP NUT is RAP_NUT.

20. The method of claim 17, wherein the RAP information parameter specifies a RAP NAL unit type as one of a broken link access (BLA) with leading pictures (LP), a BLA with decodable leading pictures (DLP), a BLA with no LP, an instantaneous decoding refresh (IDR) with DLP, an IDR with no LP, and a clean random access (CRA) NUT.
